(19) United States
(12) Patent Application Publication
(10) Pub. No.: US 2015/0021892 A1
(43) Pub. Date: Jan. 22, 2015

(54) RAIL AND METHOD OF MAKING AND USING THE SAME

(71) Applicant: GM Global Technology Operations LLC, Detroit, MI (US)

(72) Inventors: EDWARD D. MOSS, COMMERCE TOWNSHIP, MI (US); ROBERT N. SAJE, SHELBY TOWNSHIP, MI (US); PETER M. PARLOW, COLUMBUS, MI (US); GILES D. BRYER, NORTHVILLE, MI (US); ARTUR WYSZYNSKI, OXFORD, MI (US)

(21) Appl. No.: 14/323,392

(22) Filed: Jul. 3, 2014

Related U.S. Application Data
(60) Provisional application No. 61/857,153, filed on Jul. 22, 2013.

(51) Int. Cl. B62D 21/02; B62D 27/06; B62D 27/02; B23K 31/02; B62D 65/00

(52) U.S. Cl. CPC B62D 21/02; B23K 31/02; B62D 65/00; B62D 27/023; B62D 27/06
USPC 280/785; 228/101; 29/428

(57) ABSTRACT

A number of variations includes a rail and method of manufacture thereof wherein a rail may be fabricated from a first segment, a first node, and a second segment, wherein the first segment is attached to the first node, wherein the second segment is attached to the first node, and wherein the first node comprises a pre-machined hollow aluminum casting comprising at least one chassis component mounting point for attachment.

### CROSS-REFERENCE TO RELATED APPLICATIONS

This application claims the benefit of U.S. Provisional Application No. 61/857,153 filed Jul. 22, 2013.

### TECHNICAL FIELD

The field to which the disclosure generally relates to includes structural components including, but not limited to, rails used in vehicle frames and structures, such as, but not limited to, frames or structures included in passenger vehicles.

### BACKGROUND

Currently, some structural components may be formed out of a single material in a predetermined shape and then machined to fit a desired application.

### SUMMARY OF ILLUSTRATIVE VARIATIONS OF THE INVENTION

A number of variations may include a product comprising a rail comprising a first segment, a first node, and a second segment, wherein the first segment may be attached to the first node, wherein the second segment may be attached to the first node, and wherein the first node comprises a pre-machined hollow aluminum casting comprising at least one chassis component mounting point for attachment and at least one flange that enables the second segment to be top-loaded.

A number of variations may include a product comprising a rail comprising a first segment, a first node, a second segment, a second node, and a third segment, wherein the first segment may be attached to the first node, wherein the second segment may be attached to the first node and the second node, and wherein the third segment may be attached to the second node, wherein at least one of the first node or the second node comprises a pre-machined hollow aluminum casting comprising at least one chassis component mounting point for attachment and at least one flange that enables the second segment to be top-loaded.

A number of variations may include method comprising: providing a plurality of components comprising a first segment, a second segment, and a first node comprising a pre-machined hollow aluminum casting comprising at least one chassis component mounting point for attachment and at least one flange that enables the second segment to be top-loaded, attaching the first node to an assembly fixture; top loading the second segment to abut the first node by sitting on top of the at least one flange; and axially inserting the first segment into the first node to form a segmented rail which requires no post assembly machining.

A number of variations may include a method comprising providing a plurality of components comprising a first segment, a second segment, a third segment, a first node comprising a pre-machined hollow aluminum casting comprising at least one chassis component mounting point for attachment, at least one fixture mounting point and at least one flange that enables the second segment to be top-loaded, and a second node comprising a pre-machined hollow aluminum casting comprising at least one chassis component mounting point for attachment, at least one fixture mounting point and at least one flange that enables the second segment to be top-loaded; attaching the first and second node to an assembly fixture; top loading the second segment to abut the first node and the second node simultaneously by sitting on top of the at least one flange; axially inserting the first segment into the first node; and axially inserting the third segment into the second node to form a segmented rail which requires no post assembly machining.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 illustrates a perspective view of a rail according to a number of variations.

FIG. 2 illustrates a perspective view of a node according to a number of variations.

FIG. 3 illustrates a perspective view of a node according to a number of variations.

FIG. 4 illustrates a perspective view of a node according to a number of variations.

### DETAILED DESCRIPTION OF ILLUSTRATIVE VARIATIONS OF THE INVENTION

The following description of the variations is merely illustrative in nature and is in no way intended to limit the invention, its application, or uses.

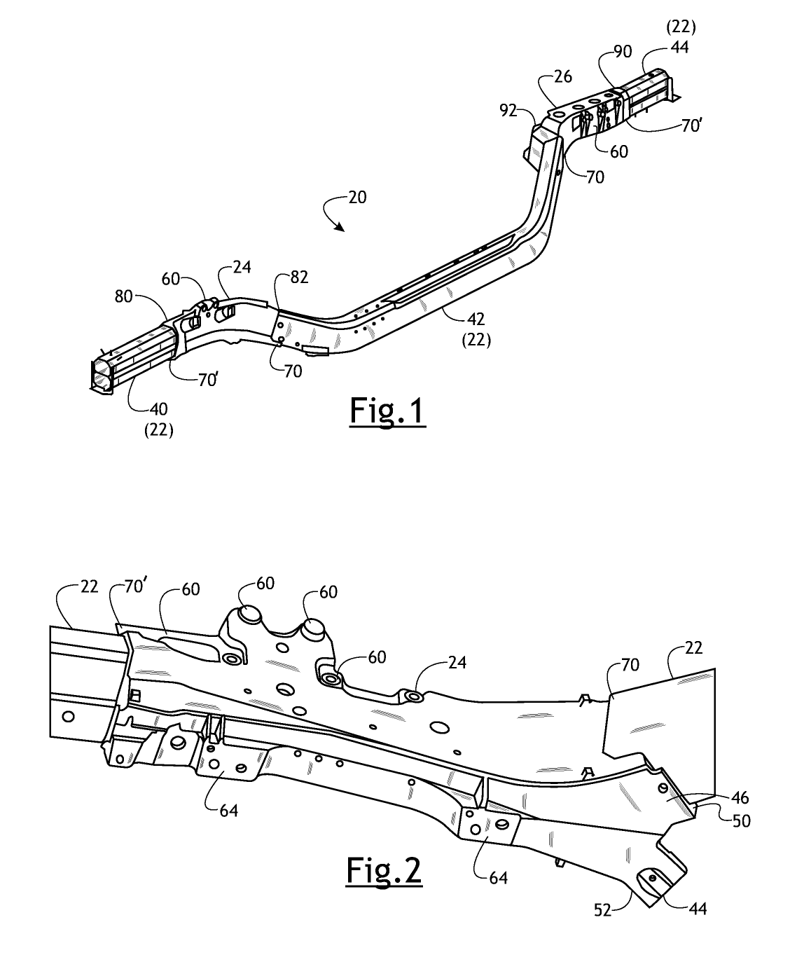

FIG. 1 illustrates a rail 20 according to a number of variations. In a number of variations, the rail 20 may be useful as components including, but not limited to, segmented rails used in vehicle frames and structures, such as, but not limited to, frames or structures included in passenger vehicles. In a number of variations, the rail 20 may combine a plurality of optimized segments 22 to meet performance requirements for multiple applications and increase mass production and ease of assembly. In a number of variations, the rail 20 may negate post-assembly dimensional machining. In a number of variations, the rail 20 may include at least one segment 22 and at least one node 24. In a number of variations, the rail 20 may include a plurality of segments 22 and nodes 24. In one variation, the rail 20 may include a first segment 40, a first node 24, and a second segment 42. In one variation, the rail 20 may include a first segment 40, a first node 24, a second segment 42, a second node 26, and a third segment 44.

In a number of variations, the segment 22 may contain a material comprising a metal. In a number of variations, the segment 22 may contain a metal including aluminum and various aluminum alloys, steel, carbon fiber reinforced polymer, carbon fiber reinforced plastic, carbon fiber reinforced thermoplastic, carbon fiber nanotube reinforced polymer, carbon composite, carbon nanotubes or may be another type. In a number of variations, the segment 22 may be tubular. In a number of variations, the segment 22 may have at least one divider inside the cross-section which splits the hollow interior of the cross-sectional into a plurality of hollow regions. The hollow regions may be of any shape in circumference. In one variation, the segment 22 cross-section may be two octagons with a shared side. In a number of variations, the segment 22 cross-section may change shape along the length of the segment to meet its specific application. In one variation, the segment 22 cross-section may be a modified square with indentations along the length of the segment. In one variation, the segment 22 may be generally linear and elongated in shape. In one variation, the segment 22 may be non-linear and elongated in shape or curved along its axis or length. In a number of variations, the segment 22 may have a plurality of ends. In a number of variations, the segment 22 may be 6000 or 7000 series aluminum. In one variation, the segment 22 may be a crush-tube or a crush can. In a number of variations, the segment 22 may be constructed and arraigned for optimization of the rail 20 during vehicle crashes. In one variation, the segment 22 may be hydroformed aluminum with a circumference of 6 inches. In one variation, the segment 22 may have a thickness of 4 mm. In one variation, a first segment 40 may be thinner than a second segment 42 by at least half. In one variation, a third segment 44 may be thinner than a second segment 42 by at least half. In a number of variations, the segment 22 may have a first or second end trimmed to allow for alignment with a node 24.

In a number of variations, a segment 22 may be formed by an extrusion process. In a number of variations, a segment 22 may be formed by a hydroforming process. In a number of variations, a segment 22 may be formed by a roll-forming process.

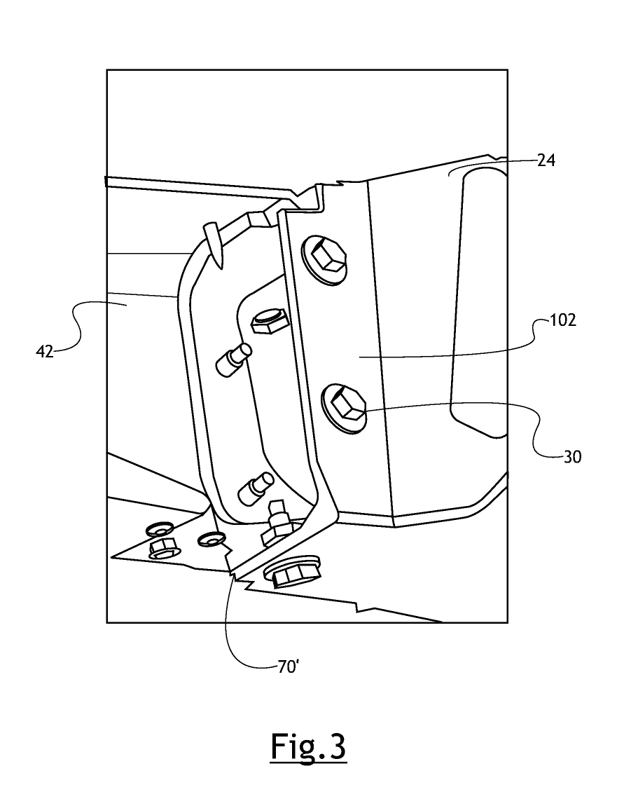

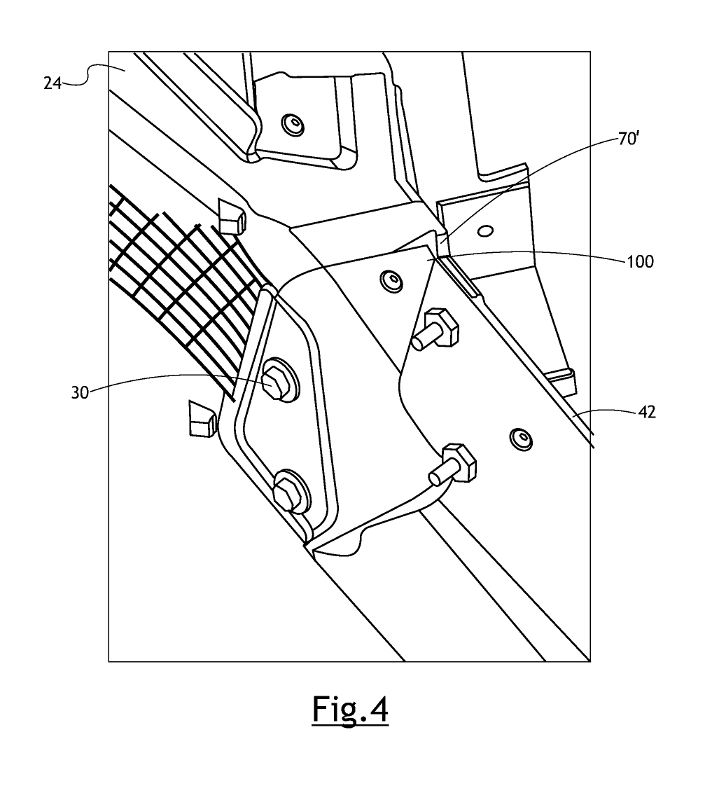

As shown in FIG. 2, the node 24 may contain a material comprising a metal. In one variation, the node 24 may contain a metal including aluminum and various aluminum alloys, steel, carbon fiber reinforced polymer, carbon fiber reinforced plastic, carbon fiber reinforced thermoplastic, carbon fiber nanotube reinforced polymer, carbon composite, carbon nanotubes or may be another type. In a number of variations, the node 24 may be tubular. In a number of variations, the node 24 may have a plurality of ends. In a number of variations, the node 24 may be generally linear and elongated in shape. In a number of variations, the node 24 may be non-linear and elongated in shape or curved along its axis or length. In one variation, the node 24 may be cast aluminum alloy. In one variation, the node 24 may be formed by a steel die to form the exterior design of the node 24 and a sand core inside the steel tool to form the interior design of the node 24. In a number of variations, the node 24 may be pre-machined. In one variation, the node 24 may have a width in the range of 2-6 inches. In one variation, the node 24 may have a length in the range of 22-26 inches. In one variation, the node 24 may have a height of 4-6 inches. In one variation, the node may have a material thickness in the range of 4-20 millimeters. In one variation, the node 24 may be open at one end and closed at another end. In one variation, the node 24 may contain an open end for attachment to a segment 22. In one variation, the node 24 may include a closed end for attachment to a segment 22. In a number of variations, the node 24 may include patterns on the exterior or the interior of the node 24. In a number of variations, the node pattern may be a polygon, circle, half circle, or may be another shape. In a number of variations, the node pattern may be cut to a depth of 1-3 millimeters. In a number of variations, the node pattern may add additional strength and stiffness to the node 24. In a number of variations the node 24 may contain at least one fixture positioning point 64. In a number of variations, the fixture positioning point 64 may include two openings or holes, which may be constructed and arranged to attach to an assembly fixture (not shown) via an assembly fixture pin (not shown) for assembly of the rail 20. In a number of variations the node 24 may include at least one positional point for vehicle assembly, which may allow for reduced fore and aft tolerances of the chassis components. In a number of variations, this tolerance reduction may improve dimensional quality by minimizing build variation. In a number of variations, the node 24 may contain at least one chassis component mounting point 60 for attachment. In a number of variations, the chassis component mounting point 60 may attach the node 24 to components of a chassis such as chassis control arms, cradles, suspension, tunnel assembly, or act as dimensional mounts for the vehicle (not shown), or may attach to a different component. In a number of variations, the chassis component mounting point 64 may include at least one of a pickup point, a cradle mount, a gaging hole, or may be another type. In a number of variations, the chassis component mounting point 60 may be pre-machined to contain dimensional mounts along its length. In a number of variations, the chassis component mounting point 60 may be more heavily reinforced with material to provide bulkheading and additional support at the chassis component mounting point 60 within the node 24 and thus may be wider than other components and sections of the node 24. In a number of variations, the node 24 and/or the chassis component mounting point 60 may be constructed and arranged to accommodate and/or position at least one of a seat back panel assembly, a tub panel assembly, a front structural panel or a front hinge pillar bracing attachment (not shown). In a number of variations, the node 24 may contain at least one socket 70 constructed and arranged to accommodate and align for attachment at least one segment 22 to the node 24. In a number of variations, the socket 70′ may be located in the front region of the first node 80 and the back region of the second node 90 and may facilitate axial insertion of a segment 22. In a number of variations the socket 70 may facilitate top loading of a segment 22 to attach to one or more nodes 24. In a number of variations, the rear region of the first node 82 and front portion of the second node 92 may include an inboard portion 52 and an outboard portion 50. The outboard portion 50 may be constructed and arranged to act as a socket 70 to allow attachment and installation of a second rail segment 42 (22). In a number of variations, the node 24 may locate segments 22 on a fixture for easier alignment and attachment. Referring to FIGS. 3 and 4, in a number of variations, the socket 70 of the first node 24 and/or the second node 26 which attaches to the second rail segment 42 (22) may contain a first flange 100 that extends vertically along the outboard portion of the node 24 at the socket 70 and horizontally along the uppermost portion of the node 24 at the socket 70. In a number of variations, the socket 70 of the first node 24 and/or the second node 26 which attaches to the second rail segment 42 (22) may contain a second flange 102 that extends vertically along the inboard portion of the node 24 at the socket 70 and horizontally along the lowermost portion of the node 24 at the socket 70. The flange may be L-shaped.

In one variation, the node 24 may be formed using a method including, but not limited to, permanent mold casting. In one variation, the node 24 may be formed as an aluminum casting. In one variation, the node 24 may be pre-machined. In one variation, the node 24 may include a pre-machined hollow aluminum casting including at least one chassis component mounting point 60 for attachment. In one variation, the node 24 may be casted using a steel mold. In one variation, the node 24 may be casted using a sand core to mold the interior of the node 24. In one variation, the node 24 may be casted using a metal die to form the exterior of the node 24.

The rail 20 may be produced by various fabrication or manufacturing methods. In a number of variations, a segment 22 may be inserted into a node 24 and attached by an attachment 30. In a number of variations, the chassis component mounting point 60 may attach the node 24 to components of a chassis, suspension, or tunnel through an attachment 30. In a number of variations, the attachment 30 may include a fastener that may include a rivet, a screw, a bolt, or a welding process (including arc welding, gas metal arc welding, shielded metal arc welding, bolting, or may be another type). In a number of variations, the attachment 30 may attach the node 24 to the segment 22 on a plurality of sides of the node 24 and the segment 22. In one variation, a first segment 40 may be attached to the node 24. In one variation, a second segment 42 may be attached to the node to form a segmented rail 20 which requires no post assembly machining. In one variation, a first segment 40 may be attached to a first node 24. In one variation, a third segment 44 may be attached to a second node 26. In one variation, a second segment 42 may be attached to the first node 24. In one variation, a second segment 42 may be attached to the second node 26 to form a segmented rail 20 which requires no post assembly machining. In a number of variations, the node 24 may be attached to the segment 22 by arc welding. In a number of variations, the segmented rail 20 may be mass produced at a faster rate than other rails because of the node 24 being pre-machined to include at least one chassis component mounting point 60. In a number of variations, the segmented rail 20 may provide chassis and steering stiffness at the nodes 24, 26. In a number of variations, the segmented rail 20 may provide a low mass second segment 44. In a number of variations, the segmented rail 20 fixture 60 may provide global stiffness and local chassis attachment stiffness. In a number of variations, a first node 24 and a second node 26 fixture positioning point holes 64 may be placed onto a non-permanent assembly fixture pin (not shown). In a number of variations, a second rail segment 44 may then be attached to the first node 24 and the second node 26 by arc welding the second rail segment 44 to the socket outboard seat 46 on the first node 24 and the second node 26 respectively. In a number of variations this may eliminate the need for post-assembly machining or tool action. In a number of variations, the second rail segment 44 may be top loaded into the sockets 70 of the first node 24 and the second node 26. Referring to FIGS. 3 and 4, in a number of variations the second rail segment 44 may be top-loaded so that the second segment 44 sits on top of and abuts the first flange 100 of the first node 24 and/or the second node 26. In a number of variations, the second segment 44 may be enabled by the rail trim line of the second segment 42, first node 24 or second node 26. In a number of variations the second rail segment 44 may be top-loaded so that the second segment 44 sits on top of and abuts the second flange 102 of the first node 24 and/or the second node 26. The second rail segment 44 may be attached to the first node 24 and/or the second node 26 by an attachment 30. In a number of variations, a first segment 42 may be axially inserted into a first node 24 front socket 70′ until it bottoms out in the socket 70′. In a number of variations, a third segment 44 may be axially inserted into a second node 26 back socket 70′ until it bottoms out in the socket 70′ and forms a five segmented rail that requires no post-assembly machining. In a number of variations, the gap between the first flange 100 and the second flange 102 along the circumference of the node 24, 26 may allow for top-loading the second segment 42 into the first node 24 and/or the second node 26. In a number of variations this may eliminate the need for post-assembly machining or tool action.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including: a rail including a first segment, a first node, and a second segment, wherein the first segment is attached to the first node, wherein the second segment is attached to the first node, and wherein the first node includes a pre-machined hollow aluminum casting including at least one chassis component mounting point for attachment and at least one flange that enables the second segment to be top-loaded.

Variation 2 may include a product as set forth in Variation 1 wherein the first segment includes extruded aluminum.

Variation 3 may include a product as set forth in any of Variations 1-2 wherein the second segment includes hydroformed aluminum.

Variation 4 may include a product as set forth in any of Variations 1-3 wherein the first segment is at least half as thick as the second segment.

Variation 5 may include a product as set forth in any of Variations 1-4 wherein the first segment is attached to the first node by welding.

Variation 6 may include a product as set forth in any of Variations 1-5 wherein the second segment is attached to the first node by welding or bolting.

Variation 7 may include product that may include a first segment, a first node, a second segment, a second node, and a third segment, wherein the first segment is attached to the first node, wherein the second segment is attached to the first node and the second node, and wherein the third segment is attached to the second node, wherein at least one of the first node or the second node includes a pre-machined hollow aluminum casting including at least one chassis component mounting point for attachment and at least one flange that enables the second segment to be top-loaded.

Variation 8 may include a product as set forth in Variation 7 wherein the third segment includes extruded aluminum.

Variation 9 may include a product as set forth in any of Variations 7-8 wherein the third segment is at least half as thick as the second segment.

Variation 10 may include a product as set forth in any of Variations 7-9 wherein the third segment is attached to the second node by welding or bolting.

Variation 11 may include a product as set forth in any of Variations 7-10 wherein the second segment is attached to the second node by welding or bolting.

Variation 12 may include a method including: providing a plurality of components including a first segment, a second segment, and a first node including a pre-machined hollow aluminum casting including at least one chassis component mounting point for attachment and at least one flange that enables the segment to be top-loaded; attaching the node to an assembly fixture; top loading the second segment to abut the first node; and axially inserting the first segment into the first node to form a segmented rail which requires no post assembly machining.

Variation 13 may include a method as set forth in Variation 12 wherein the first segment includes extruded aluminum.

Variation 14 may include a method as set forth in any of Variations 12-13 wherein the second segment includes hydroformed aluminum.

Variation 15 may include a method as set forth in Variations 12-14 wherein at least one of the first segment or the second segment is attached to the first node by welding.

Variation 16 may include a method including: providing a plurality of components including a first segment, a second segment, a third segment, a first node including a pre-machined hollow aluminum casting including at least one chassis component mounting point for attachment and at least one fixture mounting point, and a second node including a pre-machined hollow aluminum casting including at least one chassis component mounting point for attachment and at least one fixture mounting point; attaching the first and second node to an assembly fixture; top loading the second segment to abut the first node and the second node simultaneously by sitting on top of the at least one flange; axially inserting the first segment into the first node; and axially inserting the third segment into the second node to form a segmented rail which requires no post assembly machining.

Variation 17 may include a method as set forth in Variation 16 wherein at least one of the first segment or the third segment includes extruded aluminum.

Variation 18 may include a method as set forth in any of Variations 16-17 wherein the second segment includes hydroformed aluminum.

Variation 19 may include a method as set forth in any of Variations 16-18 wherein at least one of the first segment or the second segment is attached to the first node by welding.

Variation 20 may include a method as set forth in any of Variations 16-19 wherein at least one of the second segment or the third segment is attached to the second node by welding.

Variation 21 may include a product as set forth in any of Variations 1-11 wherein the segment includes a metal including at least one of aluminum and various aluminum alloys, steel, carbon fiber reinforced polymer, carbon fiber reinforced plastic, carbon fiber reinforced thermoplastic, carbon fiber nanotube reinforced polymer, carbon composite, carbon nanotubes or may be another type.

Variation 22 may include a product as set forth in any of Variations 1-11 and 21-22 wherein the segment is tubular.

Variation 23 may include a product as set forth in any of Variations 1-11 and 21-22 wherein the segment includes a cross-section shaped as a circle, polygon, half circle, ellipse, or a parabola.

Variation 24 may include a product as set forth in any of Variations 1-11 and 21-23 wherein the segment includes at least one divider inside the cross-section which splits the hollow interior of the cross-sectional into a plurality of hollow regions.

Variation 25 may include a product as set forth in any of Variations 1-11 and 21-24 wherein the segment includes a cross-section shaped as two octagons with a shared side.

Variation 26 may include a product as set forth in any of Variations 1-11 and 21-25 wherein the segment cross-section changes shape along the length of the segment.

Variation 27 may include a product as set forth in any of Variations 1-11 and 21-26 wherein the segment is generally linear and elongated in shape.

Variation 28 may include a product as set forth in any of Variations 1-11 and 21-27 wherein the segment cross-section is non-linear and elongated in shape or curved along its axis or length.

Variation 29 may include a product as set forth in any of Variations 1-11 and 21-28 wherein the segment includes a plurality of ends.

Variation 30 may include a product as set forth in any of Variations 1-11 and 21-29 wherein the segment includes a 6000 or 7000 series aluminum crush can.

Variation 31 may include a product as set forth in any of Variations 1-11 and 21-30 wherein the segment includes hydroformed aluminum with a circumference of 6 inches and a thickness of 4 mm.

Variation 32 may include a product as set forth in any of Variations 1-11 and 21-31 wherein the segment includes a first or second end trimmed to allow for alignment with a node.

Variation 33 may include a product as set forth in any of Variations 1-11 and 21-32 wherein the segment is formed using a method including at least one of a extrusion process, a hydroforming process, or a roll-forming process.

Variation 34 may include a product as set forth in any of Variations 1-11 and 21-33 wherein the node includes a metal including at least one of aluminum and various aluminum alloys, steel, carbon fiber reinforced polymer, carbon fiber reinforced plastic, carbon fiber reinforced thermoplastic, carbon fiber nanotube reinforced polymer, carbon composite, carbon nanotubes or may be another type.

Variation 35 may include a product as set forth in any of Variations 1-11 and 21-34 wherein the node is tubular.

Variation 36 may include a product as set forth in any of Variations 1-11 and 21-35 wherein the node includes a cross-section shaped as a circle, polygon, half circle, ellipse, or a parabola.

Variation 37 may include a product as set forth in any of Variations 1-11 and 21-36 wherein the node includes at least one divider inside the cross-section which splits the hollow interior of the cross-sectional into a plurality of hollow regions.

Variation 38 may include a product as set forth in any of Variations 1-11 and 21-37 wherein the node is formed by a steel die to form the exterior design of the node and a sand core to form the interior design of the node.

Variation 39 may include a product as set forth in any of Variations 1-11 and 21-38 wherein the node cross-section changes shape along the length of the segment.

Variation 40 may include a product as set forth in any of Variations 1-11 and 21-39 wherein the node includes an open and a closed end for attachment to at least one segment.

Variation 41 may include a product as set forth in any of Variations 1-11 and 21-40 wherein the node has regions where it has a hollow cross-section and regions where it has a solid material cross-section along its length.

Variation 42 may include a product as set forth in any of Variations 1-11 and 21-41 wherein the node has a width in the range of 2-6 inches in diameter.

Variation 43 may include a product as set forth in any of Variations 1-11 and 21-42 wherein the node has a length in the range of 22-26 inches.

Variation 44 may include a product as set forth in any of Variations 1-11 and 21-43 wherein the node has a material thickness in the range of 4-20 millimeters.

Variation 45 may include a product as set forth in any of Variations 1-11 and 21-44 wherein the node has a height of 4-6 inches.

Variation 46 may include a product as set forth in any of Variations 1-11 and 21-45 wherein the node is generally linear and elongated in shape.

Variation 47 may include a product as set forth in any of Variations 1-11 and 21-46 wherein the node cross-section is non-linear and elongated in shape or curved along its axis or length.

Variation 48 may include a product as set forth in any of Variations 1-11 and 21-47 wherein the node includes a plurality of ends.

Variation 49 may include a product as set forth in any of Variations 1-11 and 21-48 wherein the node is cast aluminum.

Variation 50 may include a product as set forth in any of Variations 1-11 and 21-49 wherein the node includes at least one fixture positioning point.

Variation 51 may include a product as set forth in any of Variations 1-11 and 21-50 wherein the chassis component mounting point attaches the node 34 to at least one of chassis control arms, cradles, suspension, tunnel assembly, or act as dimensional mounts for the vehicle.

Variation 52 may include a product as set forth in any of Variations 1-11 and 21-51 wherein the chassis component mounting point may include at least one of a pickup point, a cradle mount, a dimensional mount, or a gaging hole

Variation 53 may include a product as set forth in any of Variations 1-11 and 21-52 wherein the chassis component mounting point may be heavily reinforced with material to provide bulkheading.

Variation 54 may include a product as set forth in any of Variations 1-11 and 21-53 wherein the chassis component mounting point may be constructed and arranged to accommodate and/or position at least one of a seat back panel assembly, a tub panel assembly, a front structural panel or a front hinge pillar bracing attachment.

Variation 55 may include a product as set forth in any of Variations 1-11 and 21-54 wherein the node contains at least one socket constructed and arranged to accommodate and align for attachment at least one segment to the node.

Variation 56 may include a product as set forth in any of Variations 1-11 and 21-55 wherein the node includes a inboard portion and an outboard portion.

Variation 57 may include a product as set forth in any of Variations 1-11 and 21-56 wherein the flange is L-shaped.

Variation 58 may include a product as set forth in any of Variations 1-11 and 21-57 wherein the node is formed using a method including permanent mold casting.

Variation 57 may include a product as set forth in any of Variations 1-11 and 21-56 wherein the node is includes an aluminum casting.

Variation 58 may include a product as set forth in any of Variations 1-11 and 21-57 wherein the node is pre-machined.

Variation 57 may include a product as set forth in any of Variations 1-11 and 21-56 wherein the rail further includes at least one attachment for attaching the node to the segment.

Variation 58 may include a product as set forth in any of Variations 1-11 and 21-57 wherein the rail further includes at least one attachment for attaching the node to components of a chassis, suspension, or tunnel.

Variation 59 may include a product as set forth in any of Variations 1-11 and 21-58 wherein the attachment includes a rivet, screw, bolt, or welding process including arc welding, resistance welding, gas metal arc welding, or shielded metal arc welding, or bolting.

Variation 60 may include a product as set forth in any of Variations 1-11 and 21-59 wherein the attachment attaches the node to the segment on a plurality of sides of the node and the segment.

Variation 61 may include a product as set forth in any of Variations 1-11 and 21-60 wherein the node includes at least one of an open or closed end for attachment to at least one segment.

Variation 62 may include a product as set forth in any of Variations 1-11 and 21-61 wherein the node includes patterns on the exterior or the interior of the node.

Variation 63 may include a product as set forth in any of Variations 1-11 and 21-62 wherein the node includes patterns on the exterior or the interior of the node that are polygonal, circular, or half circular in shape.

Variation 64 may include a product as set forth in any of Variations 1-11 and 21-63 wherein node includes patterns on the exterior or the interior of the node that are cut to a depth of 1-3 millimeters.

Variation 65 may include a method as set forth in any of Variations 11-20 wherein at least one of the first segment, the second segment, or the third segment is attached to at least one of the first node or the second node by an attachment including at least one of a rivet, screw, bolt, or welding process including arc welding, gas metal arc welding, or shielded metal arc welding, or bolting.

Variation 66 may include a method as set forth in any of Variations 11-20 and 65 wherein the node is casted using a low-pressure, semi-permanent mold.

Variation 67 may include a method as set forth in any of Variations 11-20 and 65-66 wherein the second segment is top-loaded so that the second segment sits on top of and abuts the first flange of the first node and/or the second node.

Variation 68 may include a method as set forth in any of Variations 11-20 and 65-67 wherein the second segment is top-loaded so that the second segment sits on top of and abuts the second flange of the first node and/or the second node.

The above description of select examples of the invention is merely exemplary in nature and, thus, variations or variants thereof are not to be regarded as a departure from the spirit and scope of the invention.

What is claimed is:

1. A product comprising:
a rail comprising a first segment, a first node, and a second segment, wherein the first segment is attached to the first node, wherein the second segment is attached to the first node, and wherein the first node comprises a pre-machined hollow aluminum casting comprising at least one chassis component mounting point for attachment and at least one flange that enables the second segment to be top-loaded.

2. A product as described in claim 1 wherein the first segment comprises extruded aluminum.

3. A product as described in claim 1 wherein the second segment comprises hydroformed aluminum.

4. A product as described in claim 1 wherein the first segment is at least half as thick as the second segment.

5. A product as described in claim 1 wherein the first segment is attached to the first node by welding.

6. A product as described in claim 1 wherein the second segment is attached to the first node by welding or bolting.

7. A product comprising:
a rail comprising a first segment, a first node, a second segment, a second node, and a third segment, wherein the first segment is attached to the first node, wherein the second segment is attached to the first node and the second node, and wherein the third segment is attached to the second node, wherein at least one of the first node or the second node comprises a pre-machined hollow aluminum casting comprising at least one chassis component mounting point for attachment and at least one flange that enables the second segment to be top-loaded.

8. A product as described in claim 7 wherein the third segment comprises extruded aluminum.

9. A product as described in claim 7 wherein the third segment is at least half as thick as the second segment.

10. A product as described in claim 7 wherein the third segment is attached to the second node by welding or bolting.

11. A product as described in claim 7 wherein the second segment is attached to the second node by welding or bolting.

12. A method comprising:
providing a plurality of components comprising a first segment, a second segment, and a first node comprising a pre-machined hollow aluminum casting comprising at least one chassis component mounting point for attachment and at least one flange that enables the segment to be top-loaded, attaching the node to an assembly fixture;
top loading the second segment to abut the first node; and
axially inserting the first segment into the first node to form a segmented rail which requires no post assembly machining.

13. A method as described in claim 12 wherein the first segment comprises extruded aluminum.

14. A method as described in claim 12 wherein the second segment comprises hydroformed aluminum.

15. A method as described in claim 12 wherein at least one of the first segment or the second segment is attached to the first node by welding.

16. A method comprising:
providing a plurality of components comprising a first segment, a second segment, a third segment, a first node comprising a pre-machined hollow aluminum casting comprising at least one chassis component mounting point for attachment and at least one fixture mounting point, and a second node comprising a pre-machined hollow aluminum casting comprising at least one chassis component mounting point for attachment and at least one fixture mounting point;
attaching the first and second node to an assembly fixture;
top loading the second segment to abut the first node and the second node simultaneously by sitting on top of the at least one flange;
axially inserting the first segment into the first node; and
axially inserting the third segment into the second node to form a segmented rail which requires no post assembly machining.

17. A method as described in claim 16 wherein at least one of the first segment or the third segment comprises extruded aluminum.

18. A method as described in claim 16 wherein the second segment comprises hydroformed aluminum.

19. A method as described in claim 16 wherein at least one of the first segment or the second segment is attached to the first node by welding.

20. A method as described in claim 16 wherein at least one of the second segment or the third segment is attached to the second node by welding.
